(19) United States
(12) Patent Application Publication
(10) Pub. No.: US 2026/0111593 A1
(43) Pub. Date: Apr. 23, 2026

(54) METHOD AND SYSTEMS FOR DYNAMIC DATA CONFIDENTIALITY MANAGEMENT

(71) Applicant: MASTERCARD INTERNATIONAL INCORPORATED, Purchase, NY (US)

(72) Inventors: Jitendra Singh Wadhwa, Pune (IN); Kaushal Shetty, O'fallon, MO (US); Surbhi Malhotra, Pune (IN)

(73) Assignee: MASTERCARD INTERNATIONAL INCORPORATED, Purchase, NY (US)

(21) Appl. No.: 18/922,760

(22) Filed: Oct. 22, 2024

(51) Int. Cl. G06F 21/62; G06F 21/32

(52) U.S. Cl. CPC G06F 21/6245; G06F 21/32

(57) ABSTRACT

A system and method for a document processing module to identify a compliance standard that needs to be associated with a displayed document or image on an electronic device. The compliance standard sourced from a regulatory body via an associated application program interface (API). This API, aligned with specific standards such as PCI-DSS, HIPPA, and other compliance bodies, facilitates compliance-driven dynamic scanning of a displayed document or image. The system and method utilizing an artificial intelligence (AI) module to automatically and dynamically apply the compliance standard to a shared or displayed document or image. The AI module automatically or dynamically masking relevant data during real-time screen sharing. The masked data is presented as placeholder characters (e.g., “****” or blurring) to unauthorized viewers, effectively mitigating the risks associated with shoulder surfing or unintended exposure. This is done based on the unique FIDO authentication required a/an individual(s) viewing the displayed information.

### TECHNICAL FIELD

The present invention relates to a method of using an Artificial Intelligence (AI) algorithm to identify sensitive information being actively displayed and then dynamically masking the sensitive information in the presence of an unauthorized individual.

### BACKGROUND

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly nor impliedly admitted as prior art against the present invention.

The ubiquity of mobile computing and remote work has created vulnerabilities in both personal, institutional, and corporate data management. Employees and individuals can access sensitive data almost anywhere on the planet. Institutions and corporate entities have tried to alleviate some of the risk by requiring virtual private networks (VPN) and virtual desktop infrastructure (VDI) on mobile and remote devices in an attempt to secure their data. However, once the data is displayed on a display screen it becomes vulnerable to capture in the presence of any unauthorized individual who is present. Any individual with a camera or pen and paper can capture sensitive data being displayed. An employee working on their laptop in a coffee shop or co-working space may get up to go the restroom or may not notice a person looking at their screen from behind and sensitive data could be captured.

Furthermore, the conventional practice of document exchange via email, often employing predictable combinations of personal information, poses a substantial security threat. These documents, housing un-hashed confidential data such as bank account details, medical records, or corporate data become easily accessible to individuals with the proper technical skills. The static nature of passwords further compounds the risk, potentially leading to the compromise of confidential documents in the event of a data breach.

Entities such as institutions, organizations, governments, companies, and managers of enterprise assets often allow remote access to their enterprise data via remote computers, mobile devices, and/or screen content sharing applications. Enterprise systems that offer screen or content sharing applications often fail to adequately address an entity's enterprise data security needs. The entities go to great lengths to secure their data. In many cases the entity is required by jurisdictional laws to secure certain types of information. These entities can be held liable by regulatory agencies if certain data is not securely maintained and protected in accordance with the various compliance standards. The ubiquity of screen or content sharing applications allows remote employees and other individuals to access and share almost any of an entity's enterprise's data and content.

The ubiquitous use of these systems makes it increasingly difficult for entities to comply with the various compliance standards. These systems also make it difficult for these entities to maintain the integrity of their data.

In the realm of sensitive information exchange involving medical record details, card details, expiration dates, and regulatory directives, the susceptibility to unauthorized access poses a significant challenge. Activities like shoulder surfing and inadvertent exposure during screen sharing, especially in scenarios such as IT support sessions or interactions with customer care executives, also elevate this risk.

There is currently no tool that can dynamically and automatically mask sensitive information displayed on a displayed screen when an unauthorized user is present. There is also currently no screen-content sharing application that monitors the individual users as well as the screen-content being shared to determine which if any users should have access to the screen-content being shared. Furthermore, there does not exist a tool that dynamically limits individual users' access to shared screen-content during a group screen-content sharing session. Even more so, there is no tool that monitors all of the content being displayed across various applications during a screen-content sharing session, to determine if background applications, for example, are displaying information that falls under a compliance standard or restricted sharing standard that is set by the entity that owns the information. What is needed is a system which dynamically and efficiently analyze information being displayed on a display screen and determines if the information is sensitive or should otherwise be protected. Furthermore, if there is sensitive information or information that should be protected according compliance standards or restricted entity standards being displayed, there is a need for a tool to automatically and dynamically mask this information.

### SUMMARY

In view of the above needs, a method and system for reducing the risk of data loss by using an artificial intelligence (AI) algorithm to analyze and identify sensitive information currently being shared or displayed on a display screen. The AI can identify sensitive information based upon institutional, regulatory, and compliance standards as well as inhouse rules and the like. Once sensitive information has been identified, the AI can also use onboard sensors in the computing device such as cameras, biometric scanners, and the like along with authentication systems like fast identity online (FIDO) to determine if an individual who is actively viewing the screen is authorized or trusted with the information.

In an embodiment a method for dynamically masking contents of a document is provided. The method invokes an artificial intelligence (AI)-based dynamic compliance check of any data being displayed, shared, or included in a document that is being displayed when the document is marked as confidential. The AI dynamic compliance check fetches one or more compliance standards from a repository of compliance standards and selects the appropriate compliance standard(s) based on the data included in the document. The compliance standard(s) is applied to the documents. Here, the compliance standard is applied to identify and mark contents in a document that are deemed sensitive information based on the compliance standard that has been applied/matched to the document.

In a further embodiment, the method authorizes one or more profiles using one or more authorization techniques for accessing sensitive information within a document based on the applied compliance standard. The one or more authorization techniques authenticates one or more profiles for access to the sensitive information in the document. Receiving a notification about accessing the document by one or more viewers, wherein the accessing includes at least one of viewing document through a screen-content sharing session and/or viewing on a device display screen. The method further initiates a monitoring session associated with the document upon receiving the notification about accessing of the document by the one or more viewers, the monitoring session continuously monitors identity of the one or more viewers of the documents, in run-time, using a facial recognition-based authentication service. The identity of the one or more viewers is compared with the authorized one or more profiles to identify one or more unauthorized viewers from amongst the one or more viewers who are not authorized to access to the sensitive information in the document. Upon identifying one or more unauthorized viewers, an obfuscation tool is invoked, in run-time, to perform at least one of dynamically masking, blurring, and redacting the sensitive information being displayed during displaying of the document.

In a further embodiment, the obfuscation tool is deactivated, in run-time, when the identity of the one or more viewers matches the authorized one or more profiles, wherein deactivating the obfuscation tool performs at least one of dynamically demasking or de-blurring such that the sensitive information is visible.

In an embodiment, an artificial intelligence-based authentication system determines which profile(s) amongst the one or more profiles accessing a screen content sharing session are not authorized for access to the sensitive information.

In a further embodiment, upon a determination that a specific profile amongst the one or more profiles accessing a screen content sharing session is not authorized to access to the sensitive information, invoking the obfuscation tool to dynamically and specifically only mask the sensitive information being shared with the specific profile during the screen content sharing session.

In an embodiment, the processing unit can comprise a neural processing unit (NPU), graphic processing unit (GPU), mathematical processing unit (MPU), and/or a central processing unit (CPU).

In a further embodiment, the one or more viewers matched to the one or more authorized profiles are identified using a facial recognition-based authentication service such as the fast identification online (FIDO) standard.

In an embodiment, upon a determination that a specific profile is matched to an unauthorized viewer, amongst the one or more profiles accessing a screen content sharing session the obfuscation tool is invoked in run-time. The obfuscation tool performs at least one of dynamically masking, blurring, and/or redacting the sensitive information in a document or image being shared with the unauthorized viewer associated with the specific profile during the screen content sharing session.

In an embodiment, the artificial intelligence-based dynamic compliance check analyzes the documents to identify a plurality of data fields associated with sensitive information in accordance with the one or more compliance standards.

In an embodiment, the artificial intelligence-based dynamic compliance check prompts the user via a user interface with one or more identified compliance standards and the plurality of data fields that are individually selectable for verification.

In an embodiment, upon selection of the compliance standard from the user, identifying the data fields in the documents and data from the user profile that should be hidden or masked as per the compliance standards.

In a further embodiment, wherein the data fields in the documents and data from the user profile are demasked/deblurred post fast identification online authentication of a previously unauthorized profile.

In still another embodiment, wherein the one or more compliance standards can include legal requirements, regulatory requirements, health insurance portability and accountability act (HIPPA), payment card industry data security standard (PCI-DSS), general data protection regulation (GDPR), personal identifying information (social security numbers, Aadhaar (a twelve-digit unique identity number that can be obtained voluntarily by all residents of India), national qualification card, etc.) and the like.

In an embodiment, one or more profiles are authorized for accessing one or more levels of sensitive information uses a facial recognition-based authentication service such as the fast identification online (FIDO) standard.

In an embodiment, a system and method for dynamically applying a confidentiality standard to an actively displayed document is provided. The method includes a module for analyzing a document contents. A module is also provided for organizing a database of various compliance standards and configuring and application program interface (API) for applying the compliance standard. A module for processing the analyzed document contents to determine if the document contents meet a threshold for a compliance standard is provided. An artificial intelligence (AI) module for gathering the compliance standard and analyzing the document based upon the compliance standard to identify a plurality of data fields in the analyzed document that is associated with the one or more compliance standards.

The embodiment further includes a module for verifying the identified plurality of data fields associated with the compliance standards using a user interface (UI). Once one or more data fields have been verified as being associated with one or more compliance standards, a masking module is applied to the one or more verified data fields. The masking module includes sensors for monitoring the field of view of the document and masking, hiding, or blurring the associated data fields if it has been determined that one or more activities have been detected; and wherein the masking module unmasks, unhides, or deblurs the data fields in the document once it determines that one or more conditions have been satisfied.

In still a further embodiment, during a screen content sharing session, and audio associated with a sensitive document is also subject to obfuscation. The authorized one or more profiles that have been authenticated for access to the sensitive information in the document are allowed to view and hear the sensitive information. However, for the authorized one or more profiles that have not been authenticated for access to the sensitive information in the document, any audio associated with the document is also paused are muted so that audio is not accessible to the authorized one or more profiles that have not been authenticated for access to the sensitive information in the document. In an embodiment, a compliance module is configured to provide real-time identification of a compliance standard to a document or image being actively displayed on a display device. In a further embodiment, the compliance module is configured to determine which portions of a displayed document or image require real-time dynamic data masking. In still a further embodiment, the compliance module is integrated with an application program interface (API) associated with one or more compliance standards.

In addition, the compliance module is integrated with an application program interface (API) associated with one or more compliance standards. Various compliance standards for protecting sensitive information related to PCI-DSS, HIPAA, USMR, GDPR, Aadhaar, SSN, etc. and similar types of data can be organized such that a machine learning module can be trained to apply these standards to documents and data. The standards are maintained within a database that is accessible to the compliance module API.

In a further embodiment, real-time dynamic data masking is configured to provide intelligent identification of fields within a document or image to ensure compliance with data privacy standards.

Other embodiments provide modules with fast identity online (FIDO) authentication methods that can be applied to the masking module to identify an authorized user. In an embodiment the masking module can blur the entire image or one or more specific fields of a document or image. The masking module can also mask, blur, or hide portions of a displayed document or image if it determines an unauthorized person has entered the field of view. Furthermore, the masking module can mask, blur, or hide portions of a displayed document or image if it determines there is not an authorized person presently in the field of view of the document.

The foregoing paragraphs have been provided by way of general introduction and are not intended to limit the scope of the invention disclosed herein or the claims set forth herein. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1—provides an overview diagram of the dynamic data confidentiality management system;

FIG. 2—provides a process flow diagram for providing a dynamic data confidentiality management system;

FIG. 3—provides an illustration of the dynamic data confidentiality management system;

FIG. 4—provides flow diagrams representing the enrollment module, document sharing tool, and compliance analysis;

FIG. 5—provides a flow diagram for the enrollment module;

FIG. 6—provides a flow diagram for the compliance module;

FIG. 7—provides an illustration of the obfuscation module output;

FIG. 8—provides a flow diagram of a method of automatically and dynamically masking a document in run-time; and

FIG. 9—provides an illustration of a computing platform.

The figures are described in greater detail in the description and examples below, are provided for purposes of illustration only, and merely depict typical or example embodiments of the disclosure. The figures are not intended to be exhaustive or to limit the disclosure to the precise form disclosed. It should also be understood that the disclosure may be practiced with modification or alteration, and that the disclosure may be limited only by the claims and the equivalents thereof.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Entities such as institutions, organizations, governments, companies, and managers of enterprise assets often allow remote access to their enterprise data via remote computers, mobile devices, and/or screen content sharing applications. Enterprise systems that offer screen or content sharing applications often fail to adequately address an entity's enterprise data security needs. The entities go to great lengths to secure their data. In many cases the entity is required by jurisdictional laws to secure certain types of information. These entities can be held liable by regulatory agencies if certain data is not protected and securely maintained in accordance with the various compliance standards. The ubiquity of screen or content sharing applications allows remote employees and other individuals to access and share almost any of an entity's enterprise data and content. The ubiquitous use of these systems makes it increasingly difficult for entities to comply with the various compliance standards. These systems also make it difficult for these entities to maintain the integrity of their data.

In the realm of sensitive information exchange involving medical record details, card details, expiration dates, and regulatory directives, the susceptibility to unauthorized access poses a significant challenge. Activities like shoulder surfing and inadvertent exposure during screen sharing, especially in scenarios such as IT support sessions or interactions with customer care executives, also elevate this risk.

Embodiments herein disclose a system and method to provide a dynamic data confidentially management system that dynamically and automatically masks sensitive information displayed on a display screen when an unauthorized user is present. Embodiments herein monitor individual users during a screen-content sharing session to determine which if any of the users participating in the session are authorized to access to the screen-content being shared. Furthermore, in an embodiment, the dynamic data confidentially management system dynamically limits an individual user's access to certain shared screen-content during a group screen-content sharing session if the individual user is not authorized to view the content being shared during the session.

In further embodiments detailed below, the dynamic data confidentially management system monitors all of the content being displayed across various applications during a screen-content sharing session, to determine if background applications, for example, are displaying information that falls under a compliance standard or restricted sharing standard that is set by the entity that owns the information. In a further embodiment, the dynamic data confidentially management system dynamically and efficiently analyzes information being displayed on a display screen to determine if the information is sensitive or should otherwise be protected. Furthermore, if there is sensitive information being displayed that should be protected according to the compliance standards or restricted entity standards, the dynamic data confidentially management system automatically and dynamically masks this information.

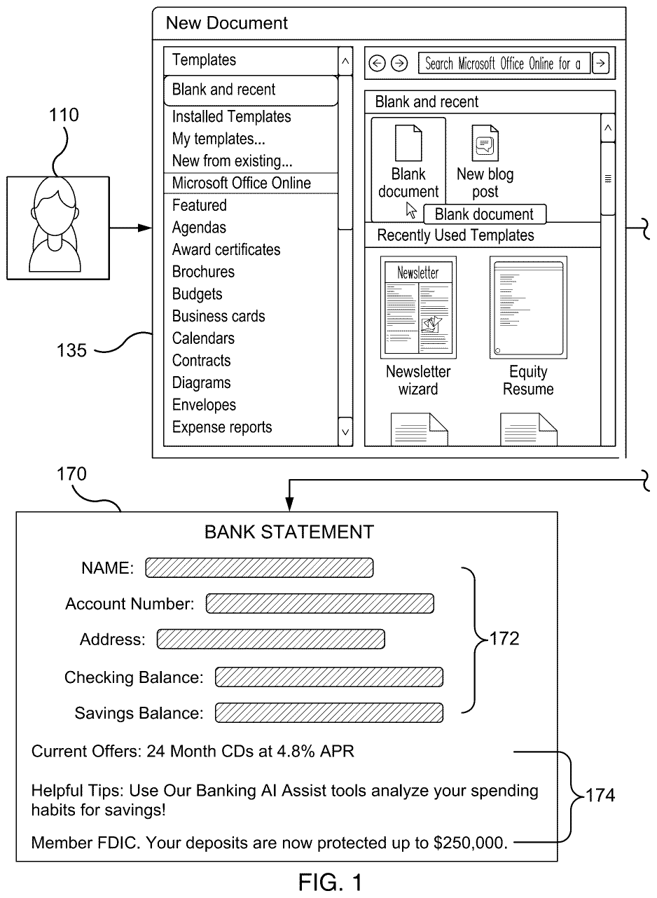

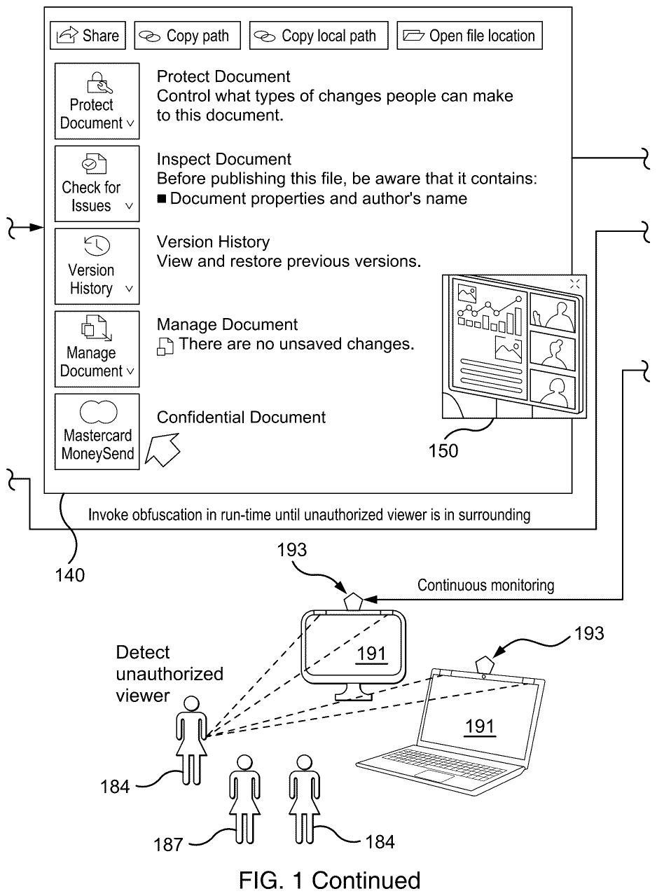

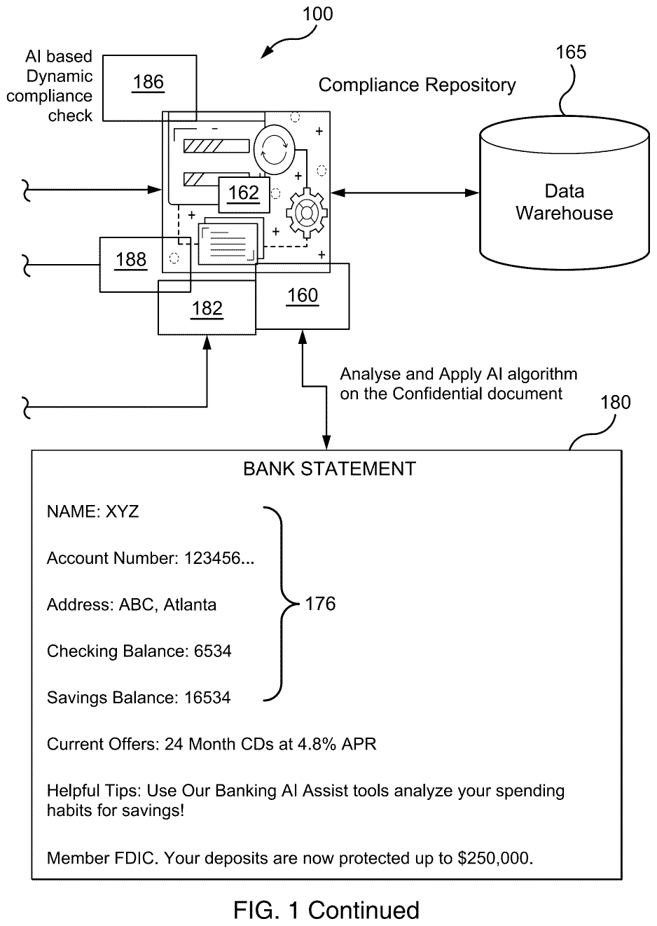

Turning now to FIG. 1; embodiments of the dynamic data confidentially management system (DDCSM) 100 also employs systems, methods, and devices for reducing the risk of data loss. In an embodiment, the DDCSM 100 executes within a computer 162 or distributed computing environment and uses a plurality of applications, algorithms, inputs, and sensors, to enable the system 100 to function. The DDCSM 100 can operate in the background below the application level unless a User 110 input is required. The DDCSM 100 uses an artificial intelligence (AI) algorithm for a dynamic compliance check 186. The AI dynamic compliance check 186 consists of the compliance repository 165 and in communication with an AI compliance check (AI CC) API 160. The AI CC 160 analyzes information or a document 180 currently being shared or displayed on a display 191 screen for sensitive information 176. The AI CC 160 is in communication with a compliance repository 165 consisting of a plurality of compliance, regulatory, and institutional databases that are designed to assist the AI CC 160 in recognizing and identifying sensitive information 176. The AI CC 160 can identify sensitive information based upon User 110 input, institutional, regulatory, and compliance standards, as well as, entity specific rules. The AI CC160 analyzes and applies User 110 identified data, institutional, regulatory, compliance standards, and rules to documents 180 and/or information being displayed or shared during a screen-content sharing session 150 or during a stand-alone display 191 screen viewing session to identify any sensitive information 176 being shared. References in the present invention to a display screen, can also include receiving audio playback either along with displayed images and documents, or simply audio being a play alone. In a further embodiment, a display screen can refer to tactile displays such a Braille displays and the like. AI CC 160 can analyze a plurality of data fields 140 within a displayed document 180 or application to determine if any compliance standards should apply. In an embodiment, the User 110 via, a user interface 135, can identify fields 140 or portions of a document that has sensitive information 176 that should be protected. The identification of any compliance standards or sensitive data can further be verified by an authorized User 110 or enterprise administrator using a user interface (UI). In an embodiment, the AICC 160 may use one or more AI algorithms to scan documents 180 and spot any sensitive information 176, then categorize it based on the type of sensitive information 176 that is found.

In an embodiment, one of the methods for identifying sensitive information 176 can involve using Natural Language Processing (NLP) techniques, such as Named Entity Recognition (NER) and text classification. These techniques can be used to identify words and fields like payment account numbers (PAN) credit/debit card numbers; names; dates; social security numbers; and other personal details. In another embodiment, the invention uses machine learning algorithms like Support Vector Machines (SVM), Random Forests, Gradient Boosting Machines (GBM), and the like to analyze a document 180 or data to identify sensitive information 176. In yet another embodiment, a deep learning models like Long and Short-Term Memory (LSTM) networks and Bidirectional Encoder Representation from Transformers (BERT), may also be used to classify whether parts of the document 180 contain sensitive information 176 or not. Further, the invention may also use pattern recognition methods, including regular expressions and rule-based systems, to find specific patterns and data fields 140 linked to sensitive information 176, such as PAN numbers, SSN number, Contact details, and the like.

In a further embodiment, once the AI CC 160 has identified sensitive information 176 displayed on the display screen of a stand-alone computer 191 or shared over a network during, for example, a screen-content sharing session 150, the DDCSM 100 further utilizes an AI authentication module (AI AM) 182 to authenticate any individuals 184, 187 who are viewing the sensitive information 176. In an embodiment, the AI AM 182 is in communication with authentication systems like fast identity online (FIDO), which can use onboard sensors 193 in the computing device such as cameras, biometric scanners, and the like to determine if an individual 184, 187 who is actively viewing the display 191 screen is authenticated and authorized to view the sensitive information 176. Therefore, a display screen of a stand-alone computer 191 may have sensors 193 for continuously monitoring the field of view of the display. The monitoring session continuously receives input from the sensors and monitors the identity of the one or more viewers of the documents, in run-time, using a fast identification online (FIDO) facial recognition-based authentication service. The FIDO facial recognition-based authentication service is used to identify and authenticate the one or more viewers associated with an authorized one or more user profiles who are authorized to access the sensitive information in the document. The FIDO facial recognition-based authentication service may be used to isolate the one or more unauthorized viewers within the field of view of the sensor 193 associated with an unauthorized or non-existing one or more user profiles and who have not been authorized to access the sensitive information in the document. An obfuscation tool is invoked, in run-time, upon identifying the one or more unauthorized viewers, to perform at least one of dynamically masking, blurring, and redacting the sensitive information being displayed during the displaying of the document on the device display screen.

Embodiments of the DDCSM 100 further includes an AI obfuscation module (AI OM) 188 that actively blurs, redacts, or masks any sensitive information 176 being displayed or shared on the display screen 191 that is viewable by an unauthorized individual 187 as identified by the AI AM 182. In a further embodiment, the AI obfuscation module (AI OM) 188 may also mute or pause any audio associated with a confidential document while the document is being obfuscated, blurred, redacted, or masked. In a similar fashion, the AI obfuscation module (AI OM) 188 that actively masks any sensitive information 176 being displayed or shared on a tactile display 191 that could be read by an unauthorized individual 187 as identified by the AI AM 182. Once the AI OM 188 receives information from the AI AM 182 that an unauthorized individual 187 is within the field of view of the display 191 screen or alternatively is in a screen-content sharing session 150 where sensitive information is being shared, the AI OM 188 instructs the computer 162 to dynamically mask, redact or blur the sensitive information 172 in the associated data fields if it has been determined that one or more unauthorized individuals 187 have been detected. In a further embodiment, only the sensitive information 172 that is being shared with the unauthorized individual 187 during a screen sharing session 150 is obfuscated. Other displayed non-sensitive information 174 remains unmasked. Other authorized individuals participating in the screen sharing session 150 can continue to view the sensitive information 176 or data. In a further embodiment, the AI OM 188 unmasks, unhides, or deblurs the data fields in the document 180 once it has been determined that one or more AI AM 182 conditions have been satisfied based on one or more authentication standards such as the FIDO authentication standard. For example, if the unauthorized individual 187 moves out of the field of view (no longer shoulder surfing) the authorized user 184 can continue to view the non-obfuscated sensitive information 176.

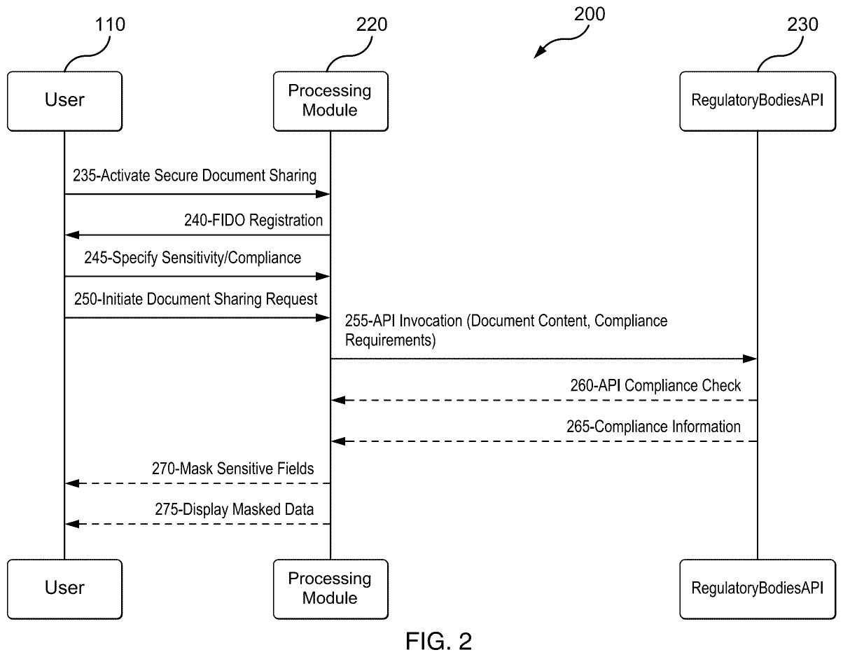

Turing now to FIG. 2, a process flow diagram is provided to illustrate an embodiment of the method for enabling dynamic data confidentiality management process 200. In the embodiment, a User 110 interacts with their computing device 162 to activate a software application. Activation of their computing device's 162 operating system, an application executing on the computing device, or for example, a screen sharing application, can trigger activation 235 of the DDCMS100. The DDCMS 100 can be an API that is present in an application or operating system executing on the computing device 162. Activation of the DDCSM 100 places the system in communication with a processing module 220. The processing module 220 can be a processing unit including a neural processing unit (NPU), graphic processing unit (GPU), mathematical processing unit (MPU), and/or a central processing unit (CPU), or a combination of these units executing within the computing device 162. The processing module 220 can also contain logic, memory, input devices, and circuitry for handling up to enterprise level requests and operations from the DDCMS 100.

The processing module 220 receives a request to display or share a document which triggers the initiation a fast identity online (FIDO) registration module 240. Authorized users 184 can register their identities and biometrics with the FIDO registration module 240. The FIDO registration module 240 processes the registration of a User's 110 credentials and assigns their level of data access as indicated by the User's 110 profile. The FIDO registration module 240 can also be a component of the AI AM 182 to assist the system in identifying authenticated users 184. The FIDO system is capable of receiving sensor input to actively determine if an authorized user 184 is viewing the computing device's display 191 screen. In combination with the DDCMS 100, the FIDO registration module 240 can also be used to help determine if one or more participants in a conference or screen-sharing session 150 are each individually authorized to view all of the content being displayed during the call.

A sensitivity and compliance component 245 responsive to the User's 110 profile, supplies data regarding the User's 110 security and authorization credentials to the processing module 220. The User 110 may provide additional details as required by the system via a user interface (UI) 315 that allows the User 110 or system administrator to adjust the sensitivity level and types of compliance regulations and scrutiny to apply to a document 180 or data being displayed to the User 110. The User 110, may also use the use the UI 315 to specify specific fields of sensitive information 176 in a document 180 that are confidential or fall under a compliance standard. These settings, inputs, and adjustments can be utilized by the AI CC 160 during its analysis of the information being presented on a display 191 or shared during a screen-content sharing session 150.

Once sensitivity and compliance levels have been set via the sensitivity and compliance component 245, the User 110 can initiate a document sharing request 250 via the UI 135. The document sharing request 250 is processed via a UI 315 at the processing module 220. The document sharing request 250 can be a screen-content sharing application, a remote access application, and the like.

In an embodiment, initiating the document sharing request 250 causes the processor 220 to invoke an API compliance module 255. The API compliance module 255 consults a database of regulatory and compliance standards managed by a regulatory bodies API 230. The regulatory bodies API 230 organizes and shares compliance standards with the AI CC 160. The AI CC 160 executes within the API compliance module 255 and uses information from the regulatory bodies API 230 to scan a document 180 or displayed data for compliance issues during an API compliance check 260 with the processing module 220. The API compliance check 260 uses one or more AI algorithms to identify one or more data fields in a document 180 associated with sensitive information 176 in accordance with one or more compliance standards. In an embodiment, the User 110 is promoted via a UI 315 with a list of one or more identified compliance standards to apply to one or more data fields 140 for verification. Upon the selection of the compliance standard from the User 110 and the identified data fields in the document 180, the portions of the document 180 and data that should be hidden or masked per the compliance standards are identified.

In an embodiment the detected compliance information 265 is processed by the processing module 220 that executes the AI CC 160 has identified sensitive information. The processing module provides this identified sensitive information to the AI OM 188 to determine which portions of the displayed data and documents should be obfuscated.

Here the AI OM 188 uses the processing module 220 to obfuscate 270 the detected compliance information 265. The AI OM 188 executes on the processing module 220 where the AI OM 188 receives data from various sensors 193 that it uses to assist the DDCMS 100 with determining when to mask sensitive data 270 and when to unmask data 275.

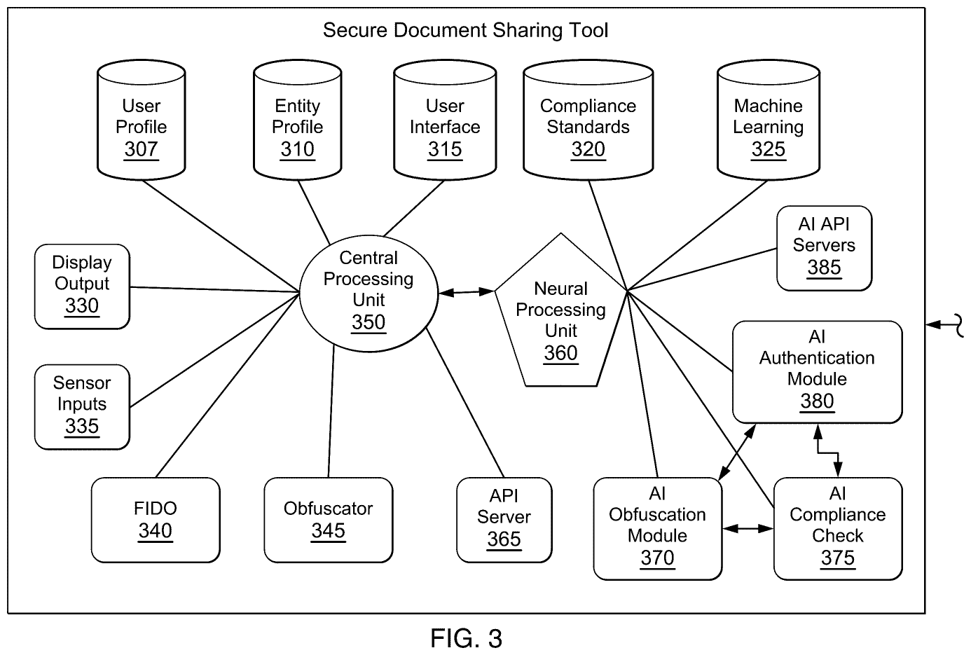

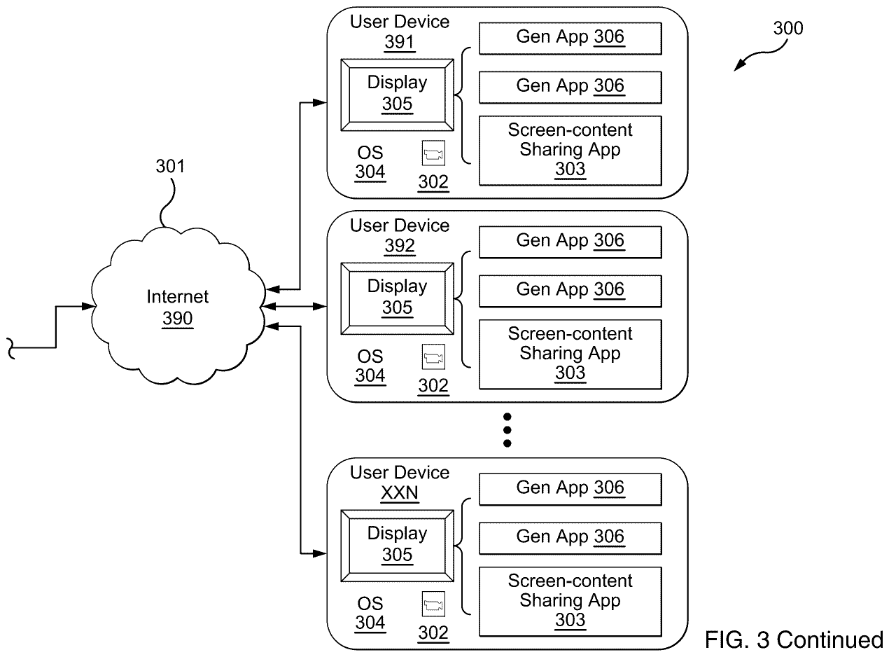

Turning now to FIG. 3, a method for providing dynamic data confidentiality management in the form of a dynamic data confidentially management system (DDCMS) 300 is provided. The DDCMS 300 can be implemented on a general computer environment, a server class environment, a distributed computing environment, or a combination of computing environments 301. In an embodiment the DDCMS 300 includes a central processing unit (CPU) 350, a neural processing unit (NPU) 360, various memory components, and circuitry for operating as a general computer or within a distributed computing environment. The NPU 360 accelerates neural network operations such as convolutions, matrix multipliers, and pattern scanning as needed to implement the invention disclosed herein.

In some embodiments, the computing environment 301 may include one or more user devices 391, 392, ... XXN, connected to the Internet 390, and accessing the DDCMS 300 via a server. In an alternative embodiment, components of the DDCMS 300 may execute on the user devices 391, 392, . . . XXN. Although user devices 391, 392, XXN are shown, it is understood that these devices could represent one or millions of user devices XXN distributed globally and to systems orbiting the Earth. These computing devices 391, 392, . . . XXN can include workstations, mobile devices, tablets, laptops, smartphones, kiosks, and the like. The User's 110 operating these devices may be end users, employees, students, customers, etc. with different level of access to various types of security restrictions.

In an embodiment, the user computing devices 391, 392, . . . XXN may each execute an instance of an operating system (OS) 304, screen-content sharing application 303, and other general applications 306, each executing within the OS 304 environment and displaying 305 data on the user's device 391, 392, . . . XXN. The general applications 306 can be internet browsers, word processing and other productivity applications, and generally any application executable on the user device 391, 392, . . . XXN. The screen-content sharing application 303 can be video conferencing software, screen-content sharing software, screen mirroring software, remote access software, and the like. In some embodiments, an application 306 or the OS 304 may be use to cast or mirror the live contents of a user's display 305 with the devices 391, 392, . . . XXN of other users. In an embodiment, the screen-sharing application 303 may capture screenshots or video casts of the state of a user's device display 305 including the control of the user interface, for sharing and control via the server-side screen-content sharing application 303 with other users computing devices 306. Collectively the applications 303 and the DDCMS 300 form a “distributed screen-content sharing application,” but this term is used to refer to the distributed application, the server-side, and client-side components interchangeably unless indicated otherwise.

In some embodiments, the client-side screen-sharing application 303 registers with the operating system 304 to receive various types of events, such as file creation events or other events indicating that a screen capture or screencast video display of the user's display 305 to another user device 391, 392, . . . XXN is occurring. Some embodiments may use an event handler to respond to these events to enable the DDCMS 300 functionality described herein. In some cases, these events may include a reference to or copy of a bitmap image or sequence of bitmap images in a video that may be accessed by the screen-sharing application 303 for purposes of Artificial Intelligence 325 analysis and subsequent operations described below.

Embodiments of the present invention can include images (or video) being shared on the user devices 391, 392, XXN that may be shared with DDCMS 300 via the Internet 390 along with an account identifier by the screen-sharing application 303 for dynamic confidentiality analysis, redaction, and sharing on the server-side. In some cases, any subset of the presently described steps of the analysis and redaction process may be offloaded to the screen-sharing application 303 for client-side processing on the user devices 391, 392, XXN and associated components to keep confidential information within an entity's network, or some embodiments may execute an on-premises instance of the screen-content sharing application 303 or a set of services related to redaction and classification and risk monitoring on-premises on remote hardware that is distinct from that hosting the DDCMS 300 and the user computing devices 391, 392, XXN.

A single instance of the various modules is shown, but embodiments are consistent with scalable architectures in which multiple instances of each module may be instantiated, for instance, behind load balancers in implementations designed to dynamically scale the number of instances responsive to computing load to concurrently process sessions.

Further, in some cases, content may be offloaded to a content delivery network in accordance with the techniques described herein. Sending instructions to retrieve content from a content delivery network is an example of sending content as that, and related phrases, and related terms are used herein.

In an embodiment, the user profile 302 can store user account records. In some embodiments, each User's 110 account record can include a user identifier, user authentication credentials (e.g. the FIDO process 240), account configuration settings, biometric matching data, current content sharing sessions under the user account, and references to user records in the other repositories.

In a further embodiment, the entity profile 310 can store entity account records. In some embodiments, each entity profile 310 can include an entity account; entity hosting sessions; entity rules and guidelines; entity level authentication systems like FIDO; entity access and security level assignments for individual users; content sharing guidelines, user interface tools, and the like. In some embodiments, the entity profile 310 may further include policies that specify who can share information with whom and which information is to be redacted or otherwise obfuscated from shared content. In some embodiments, these policies may map various sets of patterns to various teams or users, or the same set of patterns may be applied to all users of an entity's profile 310 account. The patterns may indicate which subsets of shared content are to be redacted or otherwise obfuscated. In some embodiments, the indication is a white list indication in which content that matches the pattern is not redacted. In some embodiments, the indication is a blacklist indication in which content that matches the pattern is redacted.

In still a further embodiment, the user interface 315 allows a User 110 to specify portions of a document or data 180 that are deemed to be sensitive information 176 or confidential. Data related to these specified portions can be stored in the compliance standards database 320. The CPU 350 and NPU 360 can later reference this compliance standards database 320 to allow machine learning algorithms to study similar patterns in documents and displayed images that may also contain sensitive information.

The compliance standards databases 320 can be continuously updated with newly learned steps for managing patterns that indicate which documents and images can be redacted and which documents and images can be whitelisted. A number of machine learning algorithms and APIs can be stored in a machine learning repository 325. Various types of machine learning algorithms and APIs may be required to examine different types of documents 180. Documents 180 or data with portions that have been specified by the User 110 as having sensitive information 176 can also be stored here as a reference as to which documents 180 and data are sensitive and which are not. In an embodiment, patterns may be hand coded by the User 110 or an administrator of an entity's account via the user interface 315. In some embodiments, patterns may be learned by training AI CC 160, AI AM 182 and AI OM 170 machine learning models by using training sets of prior documents 180 and data that contain sensitive information 176 and nonconfidential text. Additional embodiments may implement a hybrid approach of using both User 110 identified sensitive information 176 and sensitive information 176 that has been identified using machine learning techniques.

In an embodiment, the CPU 350 also controls output 330 to the various displays, inputs form the various sensors 335, FIDO system 340, and obfuscator 345. In an embodiment, the terms document 180 and data can represent content that is displayed to any User 110 across the distributed network of user devices 391, 392, XXN. The obfuscator 345 is directed by the AI OM 170 to determine which portions of a displayed document 180 or data to be obfuscated and the obfuscator 345 determines the electronic process for masking, redacting, or otherwise obfuscating the documents 180 and/or data. These obfuscation instructions may be distributed to a User 110 accessing the screen-content sharing application 303 across a distributed network 390. The sensor inputs 335 can include a camera system facial recognition and authentication for interacting with the DDCMS 300 system. The User 110 interacts with the DDCMS 300 system via the user interface 315.

In a further embodiment the application program interface server 365 provides access to numerous APIs for interacting with the DDCMS 300 to handle video processing, video uploads, screen captures, etc.

In some embodiments, the API server 365 executes the functionality described herein independent of the client-side screen content sharing application 303. For example, upon the User 110 interacting with the user interface 315 to indicate a document 180 or data contains sensitive information 176, the DDCSM 300 invokes the AI CC 160 to start analyzing the document 180 or data to determine which compliance standard to apply to the document 180 or data. Once the compliance standard is identified, the fields within the document 180 are categorized as either sensitive information 176 or non-sensitive. Next the AI AM 182 is invoked to continuously monitor the user device 391, 392, . . . XXN for intrusions into the device's system to detect any unauthorized viewing via internal algorithms executing with the user's device 391, 392, . . . XXN or via sensor inputs 315 to the user's device. For example, the user device 391, 392, . . . XXN can be a stand-alone computer with the DDCMS 300 installed. AI AM 182 can continuously receive inputs from the computer's onboard camera 302 to check the field of view of the display 305 for individuals. If one or more individuals are detected within the field of view of the onboard camera 302, the AI AM 182 can apply facial recognition using standards such as FIDO to determine if an authorized user 184 is viewing the display 305 and/or if an unauthorized user 187 is viewing the display 305. If an unauthorized user 187 is detected (e.g. shoulder surfing), the AI OM 170 can begin blurring and/or redacting the sensitive information 176. The sensitive information 176 will remain blurred or redacted until the AI OM 170 has determined that the unauthorized individual 187 is no longer within the field of view of the camera 302, but an authorized viewer is within the field of view of the camera 302. In a further embodiment, the AI OM 170 will only unblur or un-redact information when an authorized user 184 is the sole individual within the field of view of the camera 302, otherwise, the sensitive information 176 remains obfuscated.

Further in the embodiments, a compliance standards database 320 is provided and is in communication with the NPU 360. The NPU 360 can activate machine learning algorithms 325 in the machine learning database. These machine learning algorithms can search the compliance standards database 320 for an appropriate compliance standard for applying to documents 180 and data that are being displayed. These compliance standards are dynamically compared with the displayed documents 180 and data on the user device 391, 392, XXN. If the NPU 360 in cooperation with the AI CC 160 determines a displayed document 180 or data falls outside of the compliance standard, the AI CC 160 can take additional actions such as invoking the AI OM 170 to unmask any displayed documents 180 or data. If the displayed document 180 or data falls within the compliance standard, the AI CC 160 can select all or portions of the displayed documents 180 and data for the AI OM 170 to mask or obfuscate.

To analyze a document for confidential information using SVM network, steps like data preparation, feature extraction, model training, model evaluation, and deployment are performed. In the data preparation stage, a dataset is prepared that includes labeled examples of “confidential” and “non-confidential” text based on User 110 inputs or previous analysis. Such that, the content from the document 180 that includes both confidential and non-confidential information is gathered, and the text is then labelled “confidential” and “non-confidential.” In the feature extraction step, the text data of the shared document (all the information is considered as strings) is converted into numerical features using tokenization that splits the text into words or tokens and post that vectorization is performed to convert the tokens into numerical values. In the model training step of the SVM, the dataset is split into training and testing sets and training is performed using AI libraries. Thereafter, in model evaluation stage, the model is evaluated that it may perform well for any related confidential data. This is done by using metric accuracy and precision feedback provided to the model. Thereafter, the model is deployed which can be used for new documents which need to be analyzed using the trained model to predict if they contain confidential or sensitive information 176.

In some embodiments, patterns may be hand coded by the User 110 via the user interface 315, such as an administrator of a tenant account. In other embodiments, patterns may be learned by training machine learning models such as the AI CC 160, AI OM 170, and others in regards to historical training sets of confidential and nonconfidential documents and data. Other embodiments may implement a hybrid combination of both user inputs and machine learning models.

In an embodiment, artificial intelligence (AI) APIs can be made available to assist the DDCMS 300 and NPU 360 in enabling compliance detection, dynamic and persistent authentication, and dynamic obfuscation. The AI APIs are a set of predefined rules, protocols, and tools that integrate additional artificial intelligence capabilities into the DDCMS 300 applications, websites, or software. As these technologies improve, the AI API server 385 can be updated to provide the latest innovations in AI learning algorithms. A variety of AI APIs could potentially be used to empower the DDCMS 300 including generative AIs, textual AIs, deep analysis AIs, image processing AIs, and the like.

In a further embodiment, the AI AM 182/380 is used to authenticate any users who are viewing the information. The AI AM 182/380 receives input from the sensor inputs 335 such as web cameras, lap top cameras, or phone cameras to monitor the User 110 viewing the screen. In an embodiment, the AI AM 182/380 in communication with authentication systems like fast identity online (FIDO), which can use these onboard sensors 193 in the computing device such as the cameras, biometric scanners, and the like to determine if an individual or user who is actively viewing the display screen 305 is authenticated and authorized to view the information. The NPU 360 allows the AI AM 182/380 to dynamically process these images to continuously monitor and protect the entity's data that is being displayed or shared on a User's 110 device.

In an embodiment, the AI CC 160/375 dynamically and continually scans any documents or data currently being shared or displayed on a User's 110 display 305 screen for sensitive information 176. The AI CC 160/375 is in communication with a plurality of compliance, regulatory, and institutional databases that are designed to assist the AI CC 160/375 in discovering and identifying sensitive information. The AI CC 160/375 can identify sensitive information based upon User 110 input, institutional, regulatory, and compliance standards 320, as well as, entity specific rules. The AI CC 160/375 applies these institutional, regulatory, compliance standards 320, and rules to any documents 180 and/or information being displayed or shared during screen-content sharing session to identify any sensitive information being shared.

In an embodiment, the AI OM 170/370 is responsive to inputs from the AI CC 160/375 and AI AM 182/380. The AI CC 160/375 and AI AM 182/380 invokes the need for obfuscation based on a determination by the AI CC 160/375 that (1) the data being displayed is sensitive and needs to be protected and by AI AM 182/380 (2) providing an indication that an unauthorized individual 187 is in the field of view of the sensor inputs 335, is currently a participant in a screen-content sharing session, or if no authorized individual 187 is currently present. If a determination is made that obfuscation is needed, the AM OM 370 actively blurs, redacts, or masks any sensitive information being displayed or shared on the display 305 screen that is viewable by an unauthorized individual 187 as identified by the AI AM 182/380. Once the AI OM 170 /370 receives information from the AI AM 182/380 that an unauthorized individual 187 is within the field of view of the camera 302 or is in a screen-content sharing session where sensitive information is being shared, the AI OM 170/380 begins dynamically masking, redacting or blurring the associated data fields if it has been determined that one or more unauthorized individuals 187 have been detected. In a further embodiment, only the sensitive data that is being shared with the unauthorized individuals 187 during a screen sharing session is obfuscated. In a further embodiment the AI OM 170/380 unmasks, unhides, or deblurs the data fields in the document once it has been determined that one or more AI AM 182/380 conditions have been satisfied.

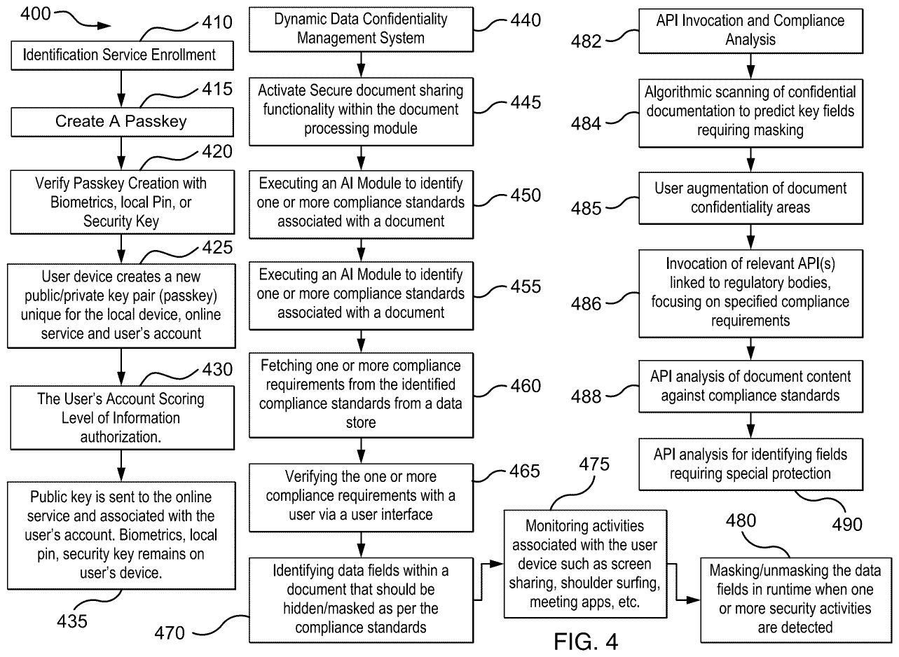

Turning now to FIG. 4, a user authentication system 400 is disclosed. In an embodiment the Users 110 are enrolled in an identification and authorization system at step 410. Once the User 110 has provided their credentials a passkey is generated 415. The User 110 is able to verify that their passkey works in step 420. The passkey is associated with the User's 110 biometrics, passwords, and any personal identification numbers. This data in then used to create a unique public/private key pair that is unique for the local device, enterprise services, and the user's account 425. The user's level of information authorization is scored and ranked 430 based upon the information the User 110 provided during enrollment. In step 435, the public key is forwarded to an online service or distributed enterprise package and associated with the User's 110 account. In an embodiment, biometric, local pin, security keys, etc. remain on the User's 110 device.

In a further embodiment, the dynamic data confidentially management system 440 can be installed on a User's 110 device 391, 392, . . . XXN or a distributed computer system 301. The dynamic data confidentially management system 440 can be activated at the kernel level within an operating system 304 or as an API associated with an application program. The DDCMS 440 is launched when the secure document sharing functionality with the document processing module 445 is activated. The dynamic data confidentially management system 440 may begin executing an AI CC 160 to identify one or more compliance standards associated with a document 450 or other data that is being displayed 455 on a display 305 screen. The AI CC 160 retrieves the one or more compliance requirements 460 from the regulatory bodies API 230. The one or more compliance requirements 460 and their levels of applicability can be adjusted or verified via a User 110 interface at step 465.

Further in the embodiment, the dynamic data confidentially management system 440 and AI CC 160 can identify portions of a document 180 or data that are regulated by a compliance standard and that may require masking or obfuscation 370. At step 475, the DDCMS 440 continuously monitors a user device 391, 392, . . . XXN for activities such screen sharing, shoulder surfing, meeting links, etc. The AI AM 182 receives sensor input and information from the FIDO system 340 to perform facial recognition when a User 110 is viewing the document 180 on a display 305 screen or during a screen-content sharing session 250. If the AI AM 182 detects individuals within the field of the view of the display 305 screen's camera 302 (e.g. should surfing) or during a screen-content sharing session 250, the dynamic data confidentially management system 440 will mask or blur sensitive data 480. When the AI AM 182 has determined that there are no security concerns, the AI AM 182 will direct the AI OM 160 to unmask 480 the sensitive information 176.

In still a further embodiment, the AI CC 160 analysis is invoked by the dynamic data confidentially management system 440 either upon start of the operating system or via an application API 482. This invocation begins the algorithmic scanning of a shared document or other data being displayed on the display screen to predict key fields that may require masking 484. The User 110 may also indicate and highlight documents or display areas of sensitive information 485. The AI CC 160 analysis applies relevant API(s) that are linked to regulatory bodies and the specific compliance requirements 486. The AI CC 160 determines which portions of a document or displayed data that may require masking, redactions, or obfuscation 488 responsive to a compliance standard. The AI CC 160 may also identify portions of a document or displayed data that may require masking, redactions, or obfuscation 490 responsive to an internal or entity standard.

In an embodiment, the AI CC 160 analysis is invoked by the dynamic data confidentially management system 440 either upon start of the operating system or via an application API 482. The dynamic data confidentially management system 440 can be activated upon a User 110 interacting with a document 180 or other data. In step 470, the User 110 is presented with a user interface 315 that allows the User 110 to select which portions of the document 180 contain sensitive information 176.

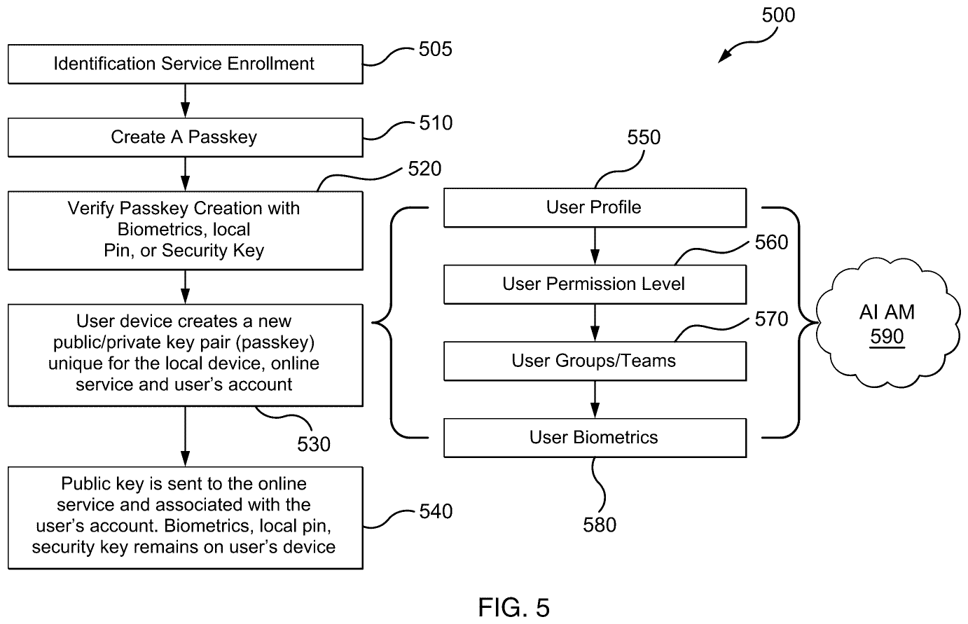

Turning now to FIG. 5, an embodiment of a flow diagram for an authentication module 500 is provided. In the embodiment, Users 110 are enrolled in an identification and authorization system at step 505. In a large enterprise environment or within a distributed computing system there can be tens if not hundreds of millions of Users 110. Every User 110 can have a unique profile, different levels of security access, and may be on different organization teams, projects, etc. within an organization. The User 110 also be a customer, system administrator, employee, service provider, or other entity outside of the organization. Once the User 110 has provided their credentials a passkey 510 is generated. The passkey 510 is associated with the user's 110 biometrics, passwords, and any personal identification numbers. This data is then used to create unique public/private key pair that unique for the local device, enterprise services, and the User's 110 account 530. The User's 110 credentialing information can be stored under a user profile 550. The user profile maintains information regarding a User's 110 current permission level 560 for authorization to access certain data within the organization or entity. The User's 110 permission level 560 may be associated with the particular position, job, team or group 570 the User 110 is a member of within the organization. The User's 110 permission level 560 and User's 110 group or team 570 may be dynamic or static. The User's 110 biometric 580 information is also stored within the profile and accessible with the passkey 510 in step 530. The public key is forwarded to an online service or distributed enterprise package and associated with the User's 110 account in step 540. In an embodiment, biometric, local pin, security keys, etc. remain on the User's 110 device.

In a further embodiment in FIG. 5, the AI authentication module (AI AM 182/590) can access and use this user profile 550 information authenticate any users who are viewing the information. The AI AM 182/590 can access cameras 302, other sensors, and passkeys 520 associated with a user profile 550 and biometrics 580 to determine who is viewing information being displayed on a display 305 screen and their associated permission level 560 for accessing the information.

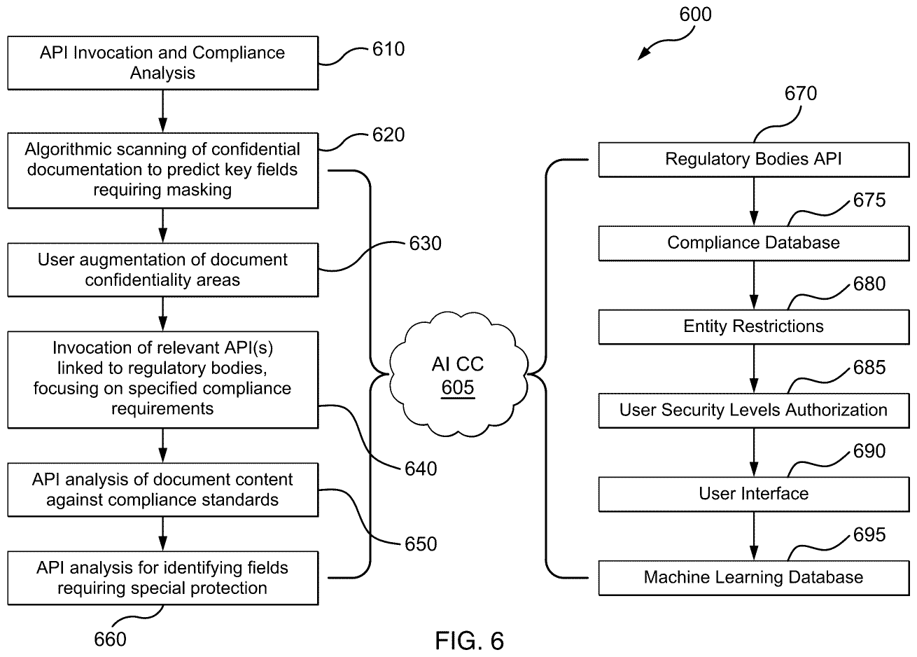

Turning now to FIG. 6, in still a further embodiment, the AI CC 160/605 analysis 600 is invoked by the dynamic data confidentially management system 440 either upon start of the operating system or via an application API at step 610. This invocation begins the algorithmic scanning of a shared document 180 or other data being displayed on the display 305 screen to predict key fields that may require masking at step 620. The system's user interface UI 690 can allow a User 110 to input or specify areas of a document or displayed data that should be protected by masking also at step 630. At step 640, the AI CC 160/605 analysis applies relevant API(s) that are linked to regulatory bodies from the regulatory bodies API 670 and their specific compliance requirements. Next at step 650, the AI CC 160/605 determines which portions of a document or displayed data that may require masking, redactions, or obfuscation responsive to a compliance standard found in the compliance database 675. The determination as to which portions of a document or displayed data that may require masking, redactions, or obfuscation can be based upon the entity's security restrictions 680 for certain types of documents and/or data at step 660. The AI CC 160/605 may also consider the User's 110 security level authorization 685 in its determination to mask, redact, or obfuscate displayed data or documents 180 in at step 660. The AI CC 160/605 can identify portions of a document or displayed data that may require masking, redactions, or obfuscation responsive to an internal or entity standard 680. The user inputs and various types and levels of masking can be studied by the AI CC 160/605 for future interactions and any learned activities can stored in a machine learning database 695.

In a further embodiment the AI OM 170/370 in communication with a display output 330 controller either on the User's 110 device our within the distributed computer network 301 via the DDCMS 300 to obfuscate the sensitive information that requires protection. The AI OM 170/370 may use any number of techniques to blur, redact, mask, or obfuscate a document, image, or sensitive information. Some of these techniques include adversarial perturbation, GAN-based image editing, deep blur methods, and the like.

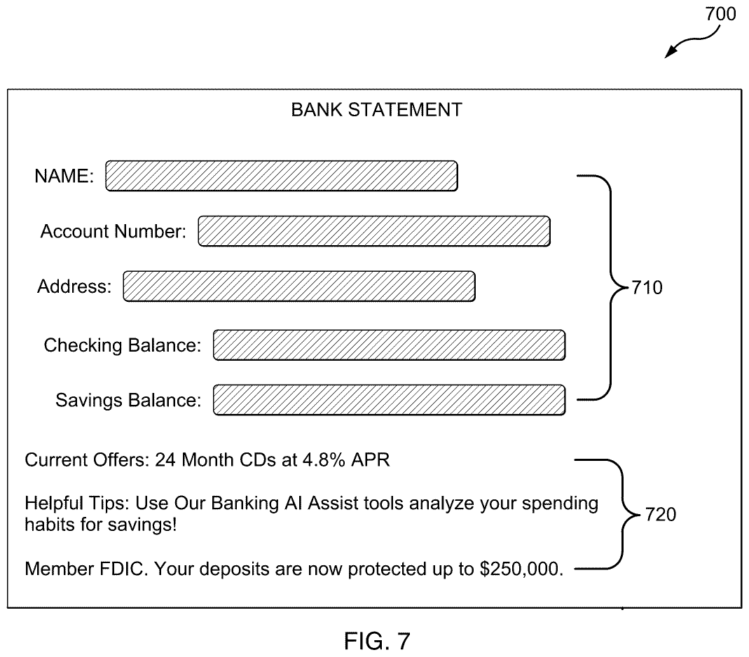

Turning now to FIG. 7, in an exemplary embodiment, if a User 110 was having technical problems with an application on their personal device 391, 392, . . . XXN and the User 110 contacts a technician for assistance; and if the technician used remote access to screen-share with the User 110, the DDCMS 300 would protect their sensitive information. For example, if the User 110 left an Internet browser window open that contained their banking information 700 during the screen-sharing session, the AI CC 160/375 can detect that this confidential information is being shared. The AI AM 182/380 would check the technician's credentials and understand that the technician was not an authenticated User 110 and was not authorized to view this banking information belonging to the User 110. Therefore, the AI AM 182/380 would invoke the AI OM 170/370 to redact any sensitive information 710 being displayed during the screen sharing session. The AI CC 160/375 would inform the AI OM 170/370 that only the sensitive information 710 required masking. In an embodiment, the information that was not determined to be sensitive 720 would remain viewable.

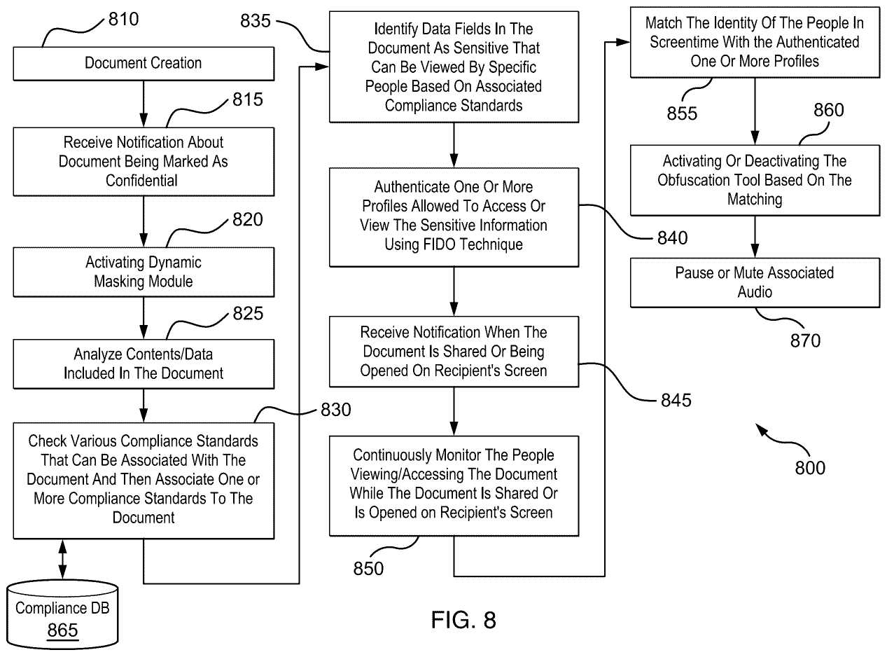

Turning now to FIG. 8, in an exemplary embodiment, a method of automatically and dynamically masking a document in run-time 800 is disclosed. Run-time can include the real-time execution of a screen-sharing application, a document processing application, web browser, or any application that is capable of displaying a document or information on a display screen. Beginning at step 810, a document is created or opened in an application on a display screen. A document in this instance can be any document, image, data, file, video, audio, or other information being displayed on display screen and/or the metadata, water marks, microdots, or other information and data associated with the document. If the document contains a confidentiality, top secret, restricted, privileged, attorney client privileged, attorney work product, HIPPA, PII, or any other confidentially marking either on the face of the document, in the document's meta-data, in microdots, or other watermarks, then the method prompts the User 110 in step 815 regarding the status of the document. Once the method prompts the User 110 regarding the confidential nature of the document in step 815, it also activates a Dynamic Masking Module in step 820.

In a further embodiment, the Dynamic Masking Module is activated in step 820. The contents and data in the documents are analyzed in step 825. This analysis in step 825 determines the type of information that is found in the document. This analysis uses machine learning, generative artificial intelligence, optical character recognition, data analysis, metadata and the like to determine the context of the document.

In an embodiment, once the analysis in step 825 is complete and an understanding of the context of the document is available, a Compliance Module is activated in step 830. The Compliance Module consults with a Compliance Standards Database 865 to determine which compliance standards are closely matched with the document. The Compliance Standards Database 865 can contain any number of professional, government, legal, regulatory, corporate, and industry specific standards. In step 830, the method uses machine learning, generative artificial intelligence, optical character recognition, data analysis, metadata and the like to apply one or more compliance standards to the document. If a further embodiment the User 110 can be promoted to confirm the compliance standard.

Once these compliance standard(s) is/are settled; these compliance standard(s) are applied to the document to identify data fields in the document that are sensitive in step 835. The application of these compliance standard(s) is/are also based upon the specific individuals authorized to view the document. In a further embodiment, one of more individual profiles are authorized to view specific data or data fields in a document. In the embodiment, a FIDO technique is applied to Authenticate the User(s) 110 viewing the information being displayed in step 840. This authentication is based on one or more user 110 profiles that are associated with the document. If a User(s) 110 viewing the display screen has a profile that is not associated with the document or if the User(s) is not authenticated then the method prepares to obfuscate and/or redact the information, data, and documents being displayed.

In a further embodiment, when the document is being opened the User 110 receives a notification that the document is being shared or opened on the Recipients display screen in step 845. The FIDO system continuously monitors the people view/accessing the document while the document is being shared or opened on a Recipient's or User's 110 display screen in step 850. In further embodiment, the FIDO system is used to continuously match the identity of individuals viewing a Recipient's or User's 110 display screen with the authenticated one or more user profiles in step 855.

While a document is being displayed on a Recipient's or User's 110 display screen the continuous monitoring is being performed by the FIDO system. In step 860, if an individual is detected who does not have a user profile associated with a shared document or if a displayed document or data filed in the document is not authorized to be shared with the authenticated User 110 profile; then the Obfuscation tool is activated. However, if the shared document or if a displayed document or data filed in the document is authorized to be shared with the authenticated User 110 profile or recipient; then the Obfuscation tool is deactivated in step 860. In still a further embodiment, any audio associated with the document is paused or muted in step 870 when the obfuscation tool is active for the document.

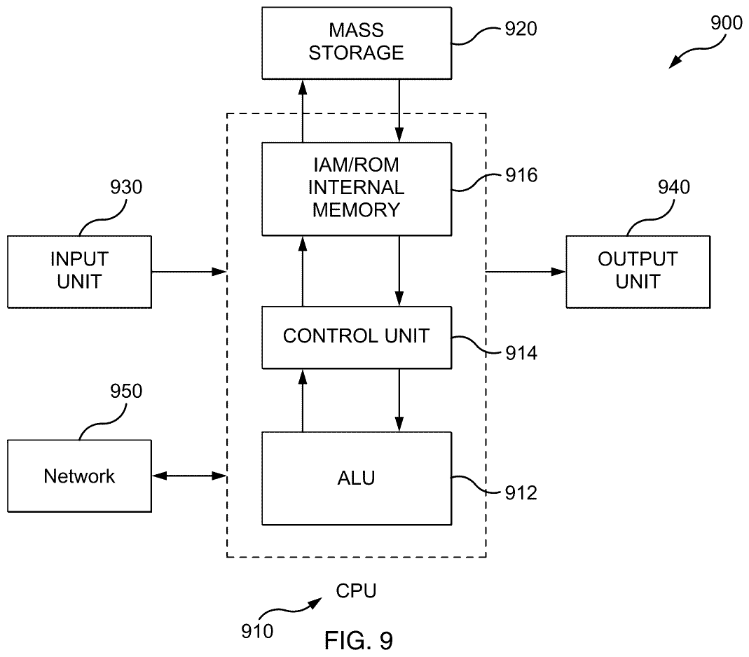

FIG. 9 illustrates a general-purpose computer 900 connected to a network 950. Indeed, in embodiments, the general-purpose computer 900 may also be a server. The general-purpose computer 900 comprises a central processing using 910 in communication with a mass storage device 920. The general-purpose computer 900 receives inputs from an input unit 930. The general-purpose computer 900 produces output via an output unit 940. A single component such as a touch screen may function as both the input unit 930 and the output unit 940. The general-purpose computer 900 is controlled using a microprocessor or central processing unit 910. The general processing unit 910 is comprised of an arithmetic logic unit 912, a control unit 914, and an internal memory 916. More generally, the general-purpose computer 900 is a data processing apparatus of the disclosure. Typically, the general-purpose computer 900 according to embodiments of the disclosure is a computer device such as a personal computer or a terminal connected to a server. Indeed, in embodiments, the general-purpose computer 900 may also be a server.

Accordingly, in so far as embodiments of the disclosure have been implemented, at least in part, by a software-controlled general-purpose computer 900, it will be appreciated that a non-transitory machine-readable medium or memory 920 carrying such software, such as an optical disk, a magnetic disk, semiconductor memory or the like, is also considered to represent an embodiment of the present disclosure.

Numerous modifications and variations of the present disclosure are possible in light of the above teachings. It is therefore to be understood that within the scope of the appended claims, the disclosure may be practiced otherwise than as specifically described herein.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments. Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. A method for dynamically masking contents of a document, the method comprising:
invoking an artificial intelligence-based dynamic compliance check of data being included in the document when the document is marked as confidential;
fetching one or more compliance standards from a repository of compliance standards for the artificial intelligence-based dynamic compliance check and invoking the artificial intelligence-based dynamic compliance check based on the data being included in the document;
applying the one or more compliance standards to the documents, wherein applying the compliance standard includes identifying and marking contents in the document that are sensitive information based on the compliance standard applied/matched to the document;
authorizing one or more profiles using one or more authorization techniques for accessing sensitive information within the document based on the applied compliance standard, wherein one or more authorization techniques authenticates one or more profiles for said access to the sensitive information in the document; and
receiving a notification about accessing of the document by one or more viewers, wherein the accessing includes at least one of viewing document through a screen-content sharing session and/or viewing on a device display screen;
initiating a monitoring session associated with the document upon receiving the notification about accessing of the document by the one or more viewers, the monitoring session continuously monitors identity of the one or more viewers of the documents, in run-time, using a facial recognition-based authentication service;
comparing the identity of the one or more viewers with the authorized one or more profiles to identify one or more unauthorized viewers from the one or more viewers who are not authorized to access to the sensitive information in the document; and
upon identifying the one or more unauthorized viewers, invoking an obfuscation tool, in run-time, to perform at least one of dynamically masking, blurring and redacting the sensitive information being displayed during displaying of the document.

2. The method according to claim 1, further comprising deactivating the obfuscation tool, in run-time, when the identity of the one or more viewers matches the authorized one or more profiles, wherein deactivating the obfuscation tool performs at least one of dynamically demasking, de-bluring, and displaying the sensitive information.

3. The method according to claim 2, wherein identifying the one or more viewers matched to the one or more authorized profiles uses a facial recognition-based authentication service such as the fast identification online (FIDO) standard.

4. The method according to claim 3, wherein upon a determination that a specific profile is matched to an unauthorized viewer, amongst the one or more profiles accessing a screen content sharing session, invoking the obfuscation tool, in run-time, to perform at least one of dynamically masking, blurring, and/or redacting the sensitive information in a document or image being shared with the unauthorized viewer associated with the specific profile during the screen content sharing session.

5. The method according to claim 1, wherein the artificial intelligence-based dynamic compliance check analyzes the documents to identify a plurality of data fields associated with sensitive information in accordance with the one or more compliance standards.

6. The method according to claim 5, wherein the artificial intelligence-based dynamic compliance check prompts the viewer via a user interface with one or more identified compliance standards that are applicable to the plurality of data fields that are individually selectable for verification of a particular compliance standard.

7. The method according to claim 1, wherein during a screen content sharing session, the authorized one or more profiles that have been authenticated for access to the sensitive information in the document are allowed to the view the sensitive information, and wherein the authorized one or more profiles that have not been authenticated for access to the sensitive information in the document are not allowed to the view the sensitive information.

8. The method according to claim 1, wherein during a screen content sharing session, any audio associated with the document that the authorized one or more profiles have been granted access to, are allowed to the view and hear the sensitive information, and wherein the authorized one or more profiles that have not been authenticated for access to the sensitive information in the document, any audio associated with the document is also paused or muted so that audio is not accessible to the authorized one or more profiles that have not been authenticated for access to the sensitive information in the document.

9. The method according to claim 1, wherein the one or more compliance standards can include legal requirements, regulatory requirements, Health Insurance Portability and Accountability act (HIPPA), Payment Card Industry Data Security Standard (PCI-DSS), General Data Protection Regulation (GDPR), personal identifying information (social security numbers, Aadhaar, national qualification card, etc.) and the like.

10. The method according to claim 1, wherein FIDO techniques are employed to continuously, in run-time, compare the identity of the one or more viewers who have an authorized one or more profile(s); with any viewers who do not have an authorized profile; from the one or more viewers who are viewing the document; and invoking the obfuscation tool if any of the one or more viewers who do not have an authorized profile are detected.

11. A method for dynamically masking contents of a document, the method comprising:
invoking an artificial intelligence-based dynamic compliance check of data being included in the document when the document is marked as confidential;
fetching one or more compliance standards from a repository of compliance standards for the artificial intelligence-based dynamic compliance check and invoking the artificial intelligence-based dynamic compliance check based on the data being included in the document;
applying the one or more compliance standards to the documents, wherein applying the compliance standard includes identifying and marking contents in the document that are sensitive information based on the compliance standard applied/matched to the document;
authorizing one or more profiles using one or more authorization techniques for accessing sensitive information within the document based on the applied compliance standard, wherein one or more authorization techniques authenticates one or more profiles for said access to the sensitive information in the document;
receiving a notification about accessing of the document by one or more viewers, wherein the accessing includes viewing document on a device display screen;
capturing, by a sensor, the field of view of the device display screen such that a monitoring session associated with the document can be initiated upon receiving the notification about accessing of the document by the one or more viewers; the monitoring session continuously receiving input from the sensors and monitoring the identity of the one or more viewers of the documents, in run-time, using a fast identification online (FIDO) facial recognition-based authentication service;
the FIDO facial recognition-based authentication service being used to identify and authenticate the one or more viewers associated with an authorized one or more user profiles who are authorized to access the sensitive information in the document; and
the FIDO facial recognition-based authentication service being used to isolate the one or more unauthorized viewers within the field of view of the sensor associated with an unauthorized or non-existing one or more user profiles and who have not been authorized to access the sensitive information in the document;
invoking an obfuscation tool, in run-time, upon identifying the one or more unauthorized viewers, to perform at least one of dynamically masking, blurring, and redacting the sensitive information being displayed during the displaying of the document on the device display screen.

12. A system for dynamically masking contents of a document, the system comprising:
a processing unit for executing artificial intelligence-based modules including:
a dynamic compliance check module for checking data being included in the document when the document is marked as confidential;
an artificial intelligence-based compliance standards module in communication with a repository of one or more compliance standards wherein the artificial intelligence-based dynamic compliance check module determines the document is marked as confidential and alerts the artificial intelligence-based compliance standards module to apply a compliance standard to the document by fetching one or more compliance standards from the repository; and
wherein the artificial intelligence-based compliance standards module matches and applies the compliance standards to the documents, wherein applying the compliance standard includes identifying and marking contents in the document that are sensitive information based on the compliance standard matched and applied to the document;
a database of one or more user profiles that are authorized, using one or more authorization techniques, to access sensitive information in the document based on the applied compliance standard; and wherein, one or more authorization techniques authenticates one or more profiles for said access to the sensitive information in the document;
a user device having a display screen for receiving a notification about accessing of the document by one or more viewers, wherein the accessing includes at least one of viewing the document via a screen-content sharing session and/or viewing the document on the user device's display screen; and
a sensor for capturing the field of view of the device display such that a monitoring session associated with the document can be initiated upon receiving the notification about accessing of the document by the one or more viewers; the monitoring session continuously receiving input from the sensors and monitoring the identity of the one or more viewers of the documents, in run-time, using a facial recognition-based authentication service;
the facial recognition-based authentication service being used to identify and authenticate the one or more viewers associated with an authorized one or more user profiles who are authorized to access the sensitive information in the document; and
the facial recognition-based authentication service being used to isolate the one or more unauthorized viewers within the field of view of the sensor associated with an unauthorized or non-existing one or more user profiles and who have not been authorized to access the sensitive information in the document;
an obfuscation tool for performing, in run-time, upon identifying the one or more unauthorized viewers, at least one of dynamically masking, blurring, and redacting the sensitive information being displayed during the displaying of the document on the device display screen.

13. The system according to claim 12, wherein the processing unit can comprise neural processing unit (NPU), graphic processing unit (GPU), mathematical processing unit (MPU), and/or a central processing unit (CPU).

14. The system according to claim 12, further comprising deactivating the obfuscation tool, in run-time, when the identity of the one or more viewers matches the authorized one or more profiles, wherein deactivating the obfuscation tool performs at least one of dynamically demasking, de-blur, and displays the sensitive information.

15. The system according to claim 14, wherein identifying the one or more viewers matched to the one or more authorized profiles uses a facial recognition-based authentication service such as the fast identification online (FIDO) standard.

16. The system according to claim 15, wherein upon a determination that a specific profile is matched to an unauthorized viewer, amongst the one or more profiles accessing a screen content sharing session, invoking the obfuscation tool, in run-time, to perform at least one of dynamically masking, blurring, and/or redacting the sensitive information in a document or image being shared with the unauthorized viewer associated with the specific profile during the screen content sharing session.

17. The system according to claim 12, wherein the artificial intelligence-based dynamic compliance check module analyzes the documents to identify a plurality of data fields associated with sensitive information in accordance with the one or more compliance standards.

18. The system according to claim 17, wherein the artificial intelligence-based dynamic compliance check module prompts the user via a user interface with one or more identified compliance standards that is applicable to the plurality of data fields that are individually selectable for verification of a particular compliance standard.

19. The system according to claim 12, wherein the one or more compliance standards can include legal requirements, regulatory requirements, Health Insurance Portability and Accountability act (HIPPA), Payment Card Industry Data Security Standard (PCI-DSS), General Data Protection Regulation (GDPR), personal identifying information (social security numbers, Aadhaar, national qualification card, etc.) and the like.

20. The system according to claim 12, wherein during a screen content sharing session, any audio associated with the document that the authorized one or more profiles have been granted access to, are allowed to the view and hear the sensitive information, and wherein the authorized one or more profiles that have not been authenticated for access to the sensitive information in the document, any audio associated with the document is also paused or muted so that audio is not accessible to the authorized one or more profiles that have not been authenticated for access to the sensitive information in the document.
